(19) United States
(12) Patent Application Publication
(10) Pub. No.: US 2005/0285412 A1
(43) Pub. Date: Dec. 29, 2005

(54) Dishwasher and door locking device for the same

(75) Inventor: Kyung Lae Kim, Sacheon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/133,250

(22) Filed: May 20, 2005

(30) Foreign Application Priority Data
May 20, 2004 (KR) 10-2004-0035890

(51) Int. Cl. E05C 3/06

(52) U.S. Cl. 292/216

(57) ABSTRACT

There is provided a dishwasher and door locking device for the same. In the door locking device, a latch body is installed in a door, a latch lock has one end inserted in an edge of a tub and the other end protruded from the edge of the tub, a latch holder is installed in the latch body for a selectively connection with the latch lock, a latch link is pivotably connected to a lower end of the latch holder, an elastic member is installed to the latch link, and an elastic force adjustor is installed to the latch link to adjust elastic force of the elastic member.

### BACKGROUND OF THE INVENTION

1. Field of the Invention

The present invention relates to a dishwasher and door locking device for the same, and more particularly, to a door locking device that is capable of securing a door lock state without loosening after door opening and closing operations are repeated for a long time.

2. Description of the Related Art

A dishwasher is an electrically operated machine that washes, rinses, and dries dishes and utensils by strongly spraying water to the dishes and utensils.

The dishwasher includes a tub forming a washing chamber, an extendable dish rack installed in the tub, a sump installed at a lower portion of the tub to store a washing water, a washing pump for pumping the washing water of the sump, and a spray nozzle for directing the pumped washing water to dishes and utensils.

Also the dishwasher includes a door pivotably installed at a front of the tub. The door is hinged to the tub at its lower portion, such that the door can be rotated about the lower portion in forward and backward directions. Therefore, a user can open and close the door by pulling and pushing a handle formed at an upper portion of the door.

To prevent the closed door from being opened by itself, a door locking device is installed between the door and the tub.

FIG. 1 is a perspective view of a door locking device for a dishwasher according to the related art.

Referring to FIG. 1, a door locking device 10 includes a latch lock 30 inserted in a upper portion of the tub, a latch 20 to be detachably coupled with the latch lock 30 for locking and unlocking the door, and a latch body (not shown) accommodating the latch 20.

The latch lock 30 includes a tub insertion portion 32 and a latch lock ring 31 at a front of the tub insertion portion 32. The tub insertion portion 32 is fixedly inserted in the tub when assembled. The latch lock ring 31 defines a hole for coupling with the latch 20.

The latch 20 includes a latch holder 21 and a latch holder hinge 25. The latch holder 21 includes a notched portion for coupling with the latch lock ring 31. The latch holder hinge 25 is formed in a horizontal direction and includes a hinge pin. The latch holder hinge 25 functions as a rotating axle of the latch holder 21.

Also, the latch 20 includes a latch link 22 and a latch spring 23. The latch link 22 is connected to a lower portion of the latch holder 21, and the latch spring 23 disposed around the latch link 22.

In detail, the latch holder 21 defines a groove with a predetermined width and length at its inside portion to receive an upper portion of the latch link 22. The lower portion of the latch holder 21 and the upper portion of the latch link 22 are connected by a variable hinge 26.

The latch link 22 includes a latch link hinge 24 formed in a horizontal direction. That is, the latch link 22 has a reversed T-shape.

An operation of the door locking device 10 will now be described.

When the door is closed, the latch lock ring 31 is hooked by the notched portion of the latch holder 21. In detail, when a use pushes the door toward the door to close the door, the latch lock ring 31 pushes the notched portion of the latch holder 21. By this pushing, the variable hinge 26 moves forward in a direction of upper arrow as it rotates about the latch holder hinge 25 and the latch link hinge 24.

During the forward movement of the variable hinge 26, the latch holder 21 and the latch link 22 are aligned in a straight line to compress the latch spring 23 maximally. Then, the variable hinge 26 further moves to a locking position symmetrical with the initial position shown in FIG. 1 to. At this locking position, the door makes tight contact with the tub, and the latch spring 23 goes back to its initial length from the maximally compressed length.

However, the door locking device 10 of the related art has a drawback in that the elastic force of the latch spring 23 becomes weak as the user repeatedly opens and closes the door. This degradation of the latch spring 23 lowers locking force of the door locking device 10, such that the door may be incomplete closed, opened by itself, and spaced from tub even when it is closed.

Further, to replace the weakened spring 23, the entire door locking device 10 has to be replaced with new one.

Furthermore, each time when a new product is developed, a new spring is designed and developed. Also, a number of samples are required to evaluate the new latch spring.

### SUMMARY OF THE INVENTION

Accordingly, the present invention is directed to a dishwasher and door locking device for the same that substantially obviates one or more problems due to limitations and disadvantages of the related art.

An object of the present invention is to provide a door locking device for a dishwasher, in which an elastic force of a latch spring is adjustable such that a latch is not changed with new one even when the elastic force of the latch spring is reduced due to a long-time repetition of door opening and closing actions.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a door locking device for a dishwasher, the door locking device including: a latch body installed in a door; a latch lock having one end inserted in an edge of a tub and the other end protruded from the edge of the tub; a latch holder installed in the latch body, the latch holder being selectively connected with the latch lock; a latch link pivotably connected to a lower end of the latch holder; an elastic member installed to the latch link; and an elastic force adjustor installed to the latch link to adjust elastic force of the elastic member.

In another aspect of the present invention, there is provided a door locking device for a dishwasher, the door locking device including: a latch lock protrusively installed at an edge of a tube, the protruded portion of the latch lock defining a hole with a predetermined size; a latch member installed in a door and having a portion for connection and disconnection with the latch lock; a latch body supporting a top and a bottom of the latch member; an elastic member fitted around the latch member; and an adjusting member fitted around the latch member to adjust an elastic force of the elastic member.

In a further another aspect of the present invention, there is provided a dishwasher including: a tub in which a washing chamber is formed; a door opening and closing a front of the tub; a latch lock protrusively installed at an edge of the tube, the protruded portion of the latch lock defining a hole with a predetermined size; a latch holder pivotably installed in the door, the latch holder being rotated when pushed by the protruded portion of the latch lock; a latch link having an upper end hinged to a lower end of the latch holder for an rotating motion; an elastic force adjusting nut fitted around the latch link; and a latch spring fitted around the latch link and seated on a top of the elastic force adjusting nut.

It is to be understood that both the foregoing general description and the following detailed description of the present invention are exemplary and explanatory and are intended to provide further explanation of the invention as claimed.

According to the present invention, the door locking device is provided with the elastic force adjustor to adjust the elastic force of the elastic member, thereby uniformly maintaining the locking force for the door.

Further, since the elastic force of the elastic member can be adjusted by the elastic force adjustor, it is not required to replace the entire door locking device with new one when the elastic force of the elastic member is reduced, thereby saving maintenance cost.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a door locking device for a dishwasher according to the related art;

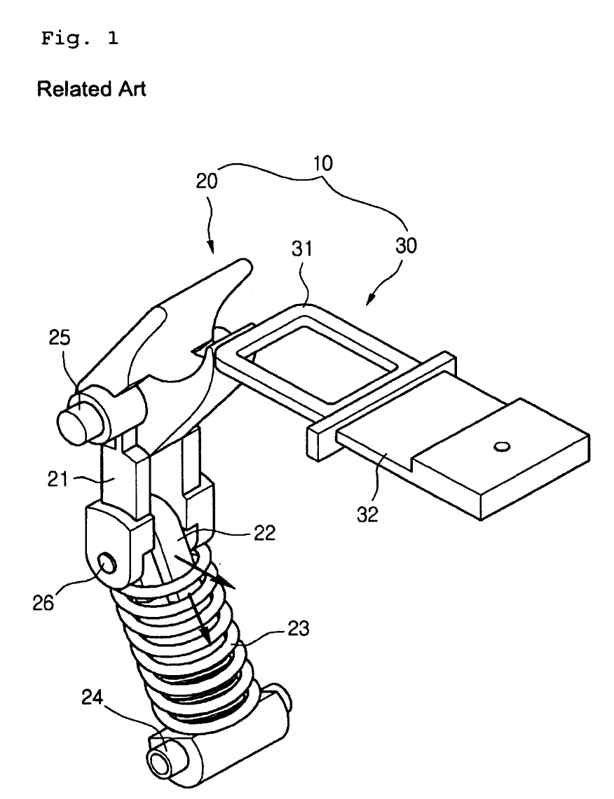

FIG. 2 is a schematic section of a dishwasher with a door locking device according to the present invention;

FIG. 3 is a perspective view of a door locking device according to the present invention;

FIG. 4 is a perspective view showing an operation between a latch and a latch lock of a door locking device according to the present invention;

FIG. 5 is a perspective view of a latch link of a door locking device according to the present invention;

FIG. 6 is a perspective view of a spring force adjusting nut according to the present invention; and

FIG. 7 is a perspective view showing an operation of the spring force adjusting nut depicted in FIG. 6.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

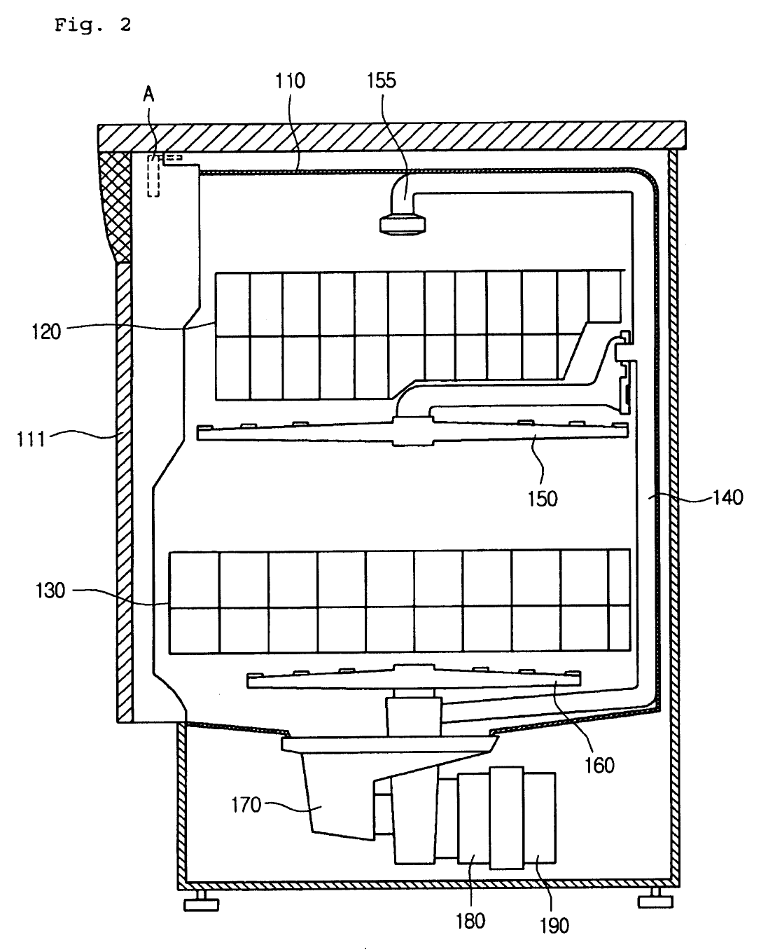

FIG. 2 is a schematic section of a dishwasher with a door locking device according to the present invention;

Referring to FIG. 2, a door locking device (A) of the present invention is installed between upper portions of a door and a tub.

A dishwasher 100 equipped with the door locking device (A) includes a tub 110 forming the outside of the dishwasher 100 and defining a washing chamber inside, a door 111 pivotably installed at a front of the tub 110 to open and close the door 111, and a sump 170 installed at a bottom center of the tub 110 to collect a washing water.

Also, the dishwasher 100 includes a washing pump 180 and a motor 190. The washing pump 180 is connected to the sump 170 to pump the washing water of the sump 170 at a high pressure, and the motor 190 is connected to a back of the washing pump 180 to drive it.

Further, the dishwasher 100 includes a water guide 140 through which the pumped washing water passes, a lower nozzle 160 mounted on the sump 170 to spray the washing water upwardly, an upper nozzle 150 disposed along a middle line of the tub 110 in connection with the water guide 140 to spray the washing water upwardly and/or downwardly, and a top nozzle 155 connected to a terminating end of the water guide 140 to spray the washing water downwardly from a top of the tub 110.

Further, the dishwasher 100 includes an extendable upper rack 120 and an extendable lower rack 130. The upper rack 120 is installed between the upper nozzle 150 and the top nozzle 155 to hold dishes and utensils when the washing water is sprayed from the upper nozzle 150 and/or the top nozzle 155. The lower rack 130 is installed between the lower nozzle 160 and the upper nozzle 150 to hold dishes and utensils when the washing water is sprayed from the lower nozzle 160 and/or the upper nozzle 150.

The upper rack 120 is slidably supported by a rail (not shown) formed on the tub 110, such that the upper rack 120 can be extended and retracted from and into the tub 110. The lower rack 130 is formed with rollers that roll along a groove defined at the door 111 when the lower rack 130 is extended from the tub 110.

An operation of the dishwasher 100 of the present invention w111 now be described.

A user opens the door 111 and extends the upper rack 120 and/or the lower rack 130 to load dishes or utensils. After loading the dishes or the utensils and closing the door 111, the user inputs washing conditions and presses an operation button to start a washing operation.

Upon the pressing of the operation button, a washing water (detergent-added water) is f111ed in the sump 170, and the motor 190 drives an impeller (not shown) of the washing pump 180 to pump the washing water from the sump 170 toward the lower nozzle 160 and the water guide 140. Here, the washing pump 180 pumps the washing water to the lower nozzle 160 and the water guide 140 in an alternating manner at regular intervals.

The water pumped to the lower nozzle 160 is sprayed upwardly to the inside of the tub 110, and the washing water pumped to the water guide 140 is sprayed to the inside of tub 110 at the top nozzle 155 and the upper nozzle 150. The sprayed washing water washes the dishes and utensils loaded in the upper rack 120 and the lower rack 130.

Herein, to wash the dishes and utensils loaded in the upper rack 120, the top nozzle 155 sprays the washing water in a downward direction, and the upper nozzle 150 sprays the washing water in an upward direction.

Also, the lower nozzle 160 sprays the washing water in an upward direction, and the upper nozzle 150 sprays the washing water from its lower spray holes in a downward direction, such that each side of the dishes and utensils loaded in the lower rack 130 can be washed.

After washing the dishes and the utensils, the contaminated washing water flows back to the sump 170 and passes through a filter (not shown). The filtered impurities are discharged by a drain pump (not shown) when the used washing water is discharged from the dishwasher 100.

After the used washing water is discharged, pure water is filled in the sump 170 through a water inlet and it is sprayed through the upper nozzle 150 and the lower nozzle 160 in the same way as described above. The sprayed pure water rinses the dishes and utensils and then it is discharged from the dishwasher 100. After this rinsing operation, a hot air is supplied to the inside of the tub to dry the dishes and utensils. That is, the dishes and utensils are cleaned through the washing, rinsing, and drying processes of the dishwasher 100.

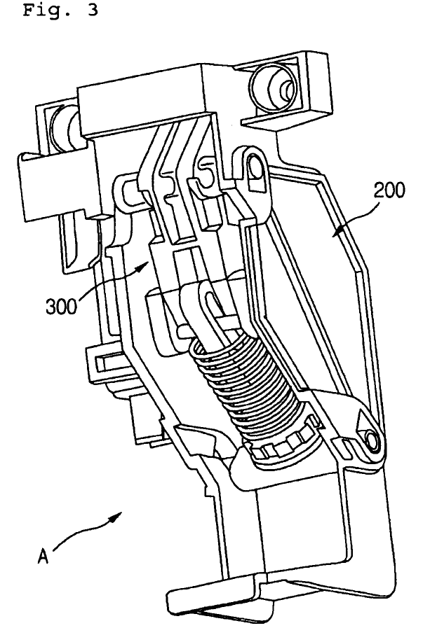

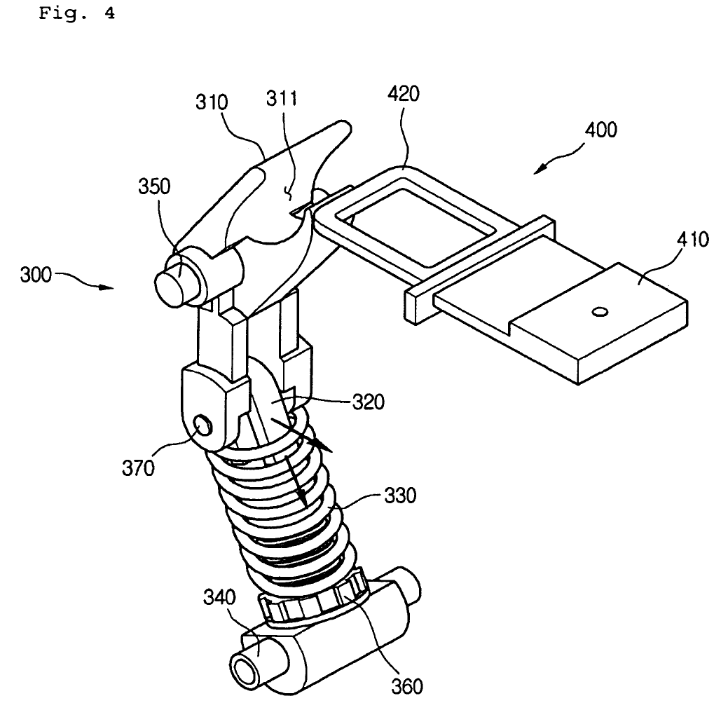

FIG. 3 is a perspective view of a door locking device according to the present invention, and FIG. 4 is a perspective view showing an operation between a latch and a latch lock of a door locking device according to the present invention.

Referring to FIGS. 3 and 4, the door locking device (A) of the present invention includes a latch body 200, a latch 300, and a latch lock 400. The latch body encloses inner parts and it is installed in the door 111. The latch 300 is hinged on the inside of the latch body 200 to lock the door 111 when the door 111 closes the tub 110, and the latch lock 400 is fixedly inserted in an upper edge of the tub 110 for coupling with the latch 300.

The latch lock 400 includes a tub insertion portion 410 and a latch lock ring 420 extended forwardly from the tub insertion portion 410. When assembled, the tub insertion portion 410 is inserted into the upper edge of the tub 110, and the latch lock ring 420 is protruded from the tub 110.

The latch body 200 includes a latch holder 310 and a latch link 320. The latch holder 310 is fitted into the latch lock ring 420 when the door 111 is closed, and the latch link 320 is pivotably connected to a lower end of the latch holder 310.

The latch holder 310 has a notched portion 311 with a predetermined depth at an upper end to couple with the latch lock ring 420. Also, the latch holder 310 includes a latch holder hinge 350 at a middle portion and a groove having a predetermined width and length along a lower center line. An upper end of the latch link 320 is inserted to the groove of the latch holder 310. Further, the latch holder 310 defines a hole at each lower end to receive a variable hinge pin 370. The variable hinge pin 370 is inserted through the holes of the latch holder 310 and the upper end of the latch link 320 to pivotably connect the lower portion of the latch holder 310 with the latch link 320.

To fit the upper end of the latch link 320 to the groove defined in the lower end of the latch holder 310, the upper end of the latch link 320 has a flat shape. Also, a variable hinge sliding slot 321 is defined in the upper end of the latch link 320 with a predetermined width and length in which the variable hinge pin 370 is inserted. That is, the variable hinge pin 370 is inserted through the holes defined in each lower end of the latch holder 310 and the variable hinge sliding slot 321 of the latch link 320 to pivotably connect the latch holder 310 and the latch link 320.

In detail, the variable hinge sliding slot 321 is extended in a length direction of the latch link 320, such that the variable hinge pin 370 can move in up and down directions along the variable hinge sliding slot 321 when the door 111 is opened and closed.

An elastic member such as a latch spring 330 is fitted around the latch link 320. Also, the latch link 320 includes a latch link hinge 340 at a lower end. The latch link hinge 340 is laterally extended in a perpendicular direction to a center line of the latch link 320. A spring force adjustor such as a spring force adjusting nut 360 is fitted around the latch link 320 between the latch spring 330 and the latch link hinge 340 to adjust the elastic force of the latch spring 330. The latch spring 330 may be a compression spring that returns to its original length when an applied compressive force is removed.

The latch 300 is installed in the latch body 200 with the latch holder hinge 350 and the latch link hinge 340 being fitted into both sides of the latch body 200. In other words, the latch holder hinge 350 and the latch link hinge 340 are pivotably fixed to the latch body 200.

An operation of the door locking device (A) will now be described.

When a user pushes the door 111 toward the tub 110 to close the door 111, the latch lock ring 420 protruded at the tub 110 is fitted into the notched portion 311 of the latch holder 310, and then the latch lock ring 420 pushes the notched portion 311 to rotate the latch holder 310 about the latch holder hinge 350 in a counterclockwise direction. Accordingly, the latch link 320 is also rotated since it is connected to the lower end of the latch holder 310 via the variable hinge pin 370.

Meanwhile, the latch holder 310 and the latch link 320 are aligned at an initial angle (unlocking angle) as shown in FIG. 4 before they are rotated, and they are aligned at a locking angle symmetrical with the unlocking angle after completely rotated. During the rotation, the latch holder 310 and the latch link 320 are aligned in a straight line.

The latch spring 330 fitted around the latch link 320 is compressed and extended by the rotation of the latch holder 310. In detail, the latch spring 330 is compressed maximally when the latch holder 310 and the latch link 320 are aligned in a straight line, and the latch spring 330 returns to its initial length when the latch holder 310 and the latch link 320 are aligned at the locking angle (when the door is completely closed and locked).

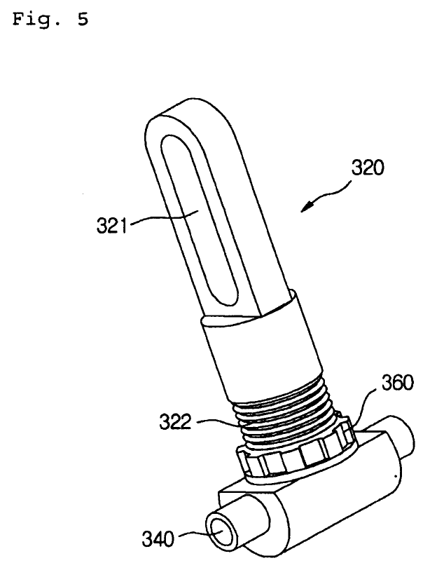

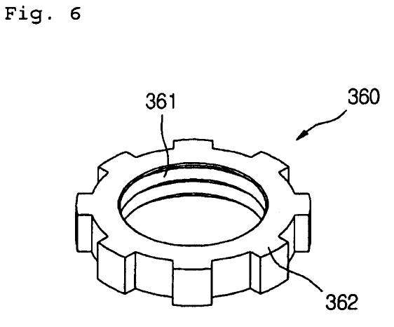

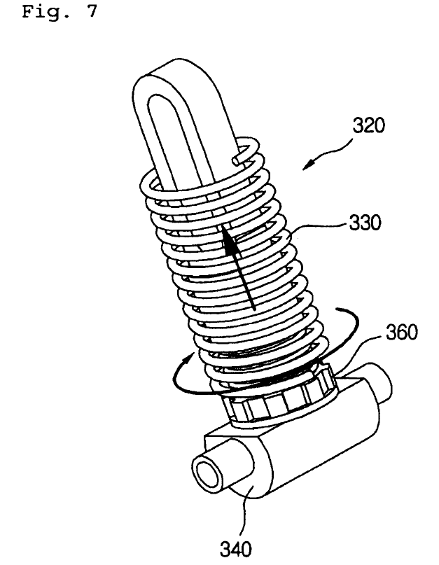

FIG. 5 is a perspective view of a latch link of a door locking device according to the present invention, FIG. 6 is a perspective view of a spring force adjusting nut according to the present invention, and FIG. 7 is a perspective view showing an operation of the spring force adjusting nut depicted in FIG. 6.

Referring to FIG. 5 to 7, the latch link 320 has a predetermined length and a circular rod shape with a flat upper portion and a threaded lower portion. The spring force adjusting nut 360 with an internal thread 361 is fitted around the threaded lower portion of the latch link 320. The spring force adjusting nut 360 moves up and down as it rotates.

The latch spring 330 can be compressed to increase its elastic resistance by rotating up the spring force adjusting nut 360. Also, the latch spring 330 can be extended to decrease its elastic resistance by rotating down the spring force adjusting nut 360.

The door 111 can be securely locked by increasing the elastic resistance of the latch spring 330. That is, the door 111 is not readily opened and closed when the elastic resistance of the latch spring 330 is increased. On the contrary, when the elastic resistance of the latch spring 330 is decreased, the locking force is also decreased, and the door 111 is readily opened and closed.

Therefore, when the elastic force of the latch spring 330 is reduced due to long use, it can be recovered with the spring force adjusting nut 360. That is, the locking force can be uniformly maintained.

It will be apparent to those sk111ed in the art that various modifications and variations can be made in the present invention. Thus, it is intended that the present invention covers the modifications and variations of this invention provided they come within the scope of the appended claims and their equivalents.

1. A door locking device for a dishwasher, comprising:
a latch body installed in a door;
a latch lock having one end inserted in an edge of a tub and the other end protruded from the edge of the tub;
a latch holder installed in the latch body, the latch holder being selectively connected with the latch lock;
a latch link connected to a lower end of the latch holder;
an elastic member installed to the latch link; and
an elastic force adjustor installed to the latch link to adjust elastic force of the elastic member.

2. The door locking device according to claim 1, wherein the elastic force adjustor is a nut fitted around the latch link.

3. The door locking device according to claim 1, wherein the latch link is formed with an external thread for engagement with the elastic force adjustor.

4. The door locking device according to claim 1, wherein the elastic member is a spring having a predetermined elastic modulus.

5. The door locking device according to claim 1, wherein the elastic member is seated on the elastic force adjustor.

6. The door locking device according to claim 1, wherein the latch link is pivotably connected to the lower end of the latch holder.

7. The door locking device according to claim 1, wherein the elastic member is maximally compressed when the latch link and the latch holder are aligned in a straight line.

8. The door locking device according to claim 1, wherein the elastic member is minimally compressed when the door is completely opened or closed.

9. The door locking device according to claim 1, wherein the latch holder and the latch link are pivotably connected with each other by a hinge and the elastic member is prevented from separating from the latch link by the lower end of the latch holder.

10. A dishwasher comprising:
a tub in which a washing chamber is formed;
a door opening and closing a front of the tub;
a latch lock protrusively installed at an edge of the tube, the protruded portion of the latch lock defining a hole with a predetermined size;
a latch holder pivotably installed in the door, the latch holder being rotated when pushed by the protruded portion of the latch lock;
a latch link having an upper end hinged to a lower end of the latch holder for an rotational motion;
an elastic force adjusting nut fitted around the latch link; and
a latch spring fitted around the latch link and seated on a top of the elastic force adjusting nut.

11. The dishwasher according to claim 10, wherein the elastic force adjusting nut is rotated up or down to adjust an elastic force of the latch spring.

12. The dishwasher according to claim 10, wherein the elastic force adjusting nut is moved up or down to increase or decrease locking force for the door.

13. The dishwasher according to claim 10, wherein the latch spring is a compression spring having a predetermined elastic force.

14. The dishwasher according to claim 10, further comprising a latch body in which the latch holder is installed with a hinge, the latch body being fixedly installed in the door.

15. A door locking device for a dishwasher, comprising:
a latch lock protrusively installed at an edge of a tube, the protruded portion of the latch lock defining a hole with a predetermined size;
a latch member installed in a door and having a portion for connection and disconnection with the latch lock;
a latch body supporting a top and a bottom of the latch member;
an elastic member fitted around the latch member; and
an adjusting member fitted around the latch member to adjust an elastic force of the elastic member.
